(19) United States
(12) Patent Application Publication
(10) Pub. No.: US 2005/0281058 A1
(43) Pub. Date: Dec. 22, 2005

(54) Dynamic optimization of efficiency using dead time and FET drive control

(76) Inventors: Issa Batarseh, Orlando, FL (US); Jaber Abu Qahouq, Orlando, FL (US); Hong Mao, Orlando, FL (US)

Correspondence Address: HARNESS, DICKEY & PIERCE, P.L.C., P.O. BOX 828, BLOOMFIELD HILLS, MI, 48303, US

(21) Appl. No.: 11/003,013

(22) Filed: Dec. 2, 2004

Related U.S. Application Data
(60) Provisional application No. 60/581,986, filed on Jun. 21, 2004.

(51) Int. Cl. H02M 3/335

(52) U.S. Cl. 363/16

(57) ABSTRACT

A power converter uses a control method to optimize efficiency by dynamically optimizing a controlled parameter. A change in efficiency of the converter after changing at least one controlled parameter is determined. The direction of change in efficiency of the converter is compared to a direction of the change in the controlled parameter. The controlled parameter is changed in a positive direction when the direction in the change in the efficiency of the converter and the direction of the change in the controlled parameter are the same and changed in a negative direction when the direction in the change in the efficiency of the converter and the direction of the change in the controlled parameter are opposite. The controlled parameters may include dead time between turn-on and turn-off and between turn-off and turn-on of the primary and corresponding secondary side switches of the controller, drive voltage(s) for the switches, and intermediate bus voltages.

### CROSS-REFERENCE TO RELATED APPLICATIONS

This application claims the benefit of U.S. Provisional Application No. 60/581,986 filed on Jun. 21, 2004.

### FIELD OF THE INVENTION

The present invention relates to power converters such as those used in power supplies, and more particularly, using dynamic optimization of efficiency by using maximum efficiency point tracking (or minimum input power point tracking).

### BACKGROUND OF THE INVENTION

In designing power electronics converter systems such as DC-DC converters, several design parameters need to be optimized to improve the efficiency and converter performance. Some of these parameters are load dependant, input voltage/output voltage dependent, components dependent, and/or temperature dependent. Designing such parameters for a specific load, input, output, components, and temperature may improve single design point efficiency but will not result in maximum efficiency and performance at different load and line conditions and will not guarantee improvement at that design point because of the components and temperature variations.

Digital controllers are increasingly being used especially in complex systems including power electronics systems because of their advantages such as the ability to perform sophisticated and enhanced control schemes, low power consumption, reliability, reconfiguration flexibility, elimination of component tolerances and ageing, and ease of integration and interface with digital systems. Of course, there are still some disadvantages/challenges in using digital controllers for analog systems such as DC-DC converters in power electronics including the required high resolution needed from the digital controller to satisfy the converter's tight regulation requirements and the required high speed digital controller to satisfy the converter's dynamic requirements. These two requirements also result in increased cost. Fortunately, digital controller technology is rapidly advancing making faster digital controllers with higher resolutions available at lower cost.

The ability of a digital controller to perform sophisticated algorithms makes it easy to apply adaptive control algorithms where system parameters can be adaptively adjusted in response to system behavior to achieve better performance and stability. An adaptive controller is therefore intuitively a controller that can modify its behavior after changes in the controlled plant or in the environment.

One important parameter that should be optimized in isolated and non-isolated converters is the dead time between the turn ON and turn OFF of the switches to avoid switch body diode conduction. For example, MOSFET body-diode conduction in the secondary side topology, such as the current doubler topology, should be avoided for better efficiency, especially for low-output voltage, high-output current applications where the body-diodes conduction loss becomes more severe requiring the smallest possible dead time (delay time) between turning ON and OFF the primary-side switches and turning OFF and ON the corresponding secondary-side switches (Synchronous Rectifiers or SRs). At the same time, this dead time should be long enough to avoid the two secondary SR switches short circuiting when the two of them are ON at the same instant and the voltage is applied from the primary side.

The selection and optimization of this dead time is not an easy task and is difficult to achieve at all load/input conditions and at different components parasitics and temperatures. One way to accomplish this is to fix the dead time to a constant value that satisfies the worst condition. This can be achieved by a simple RC (Resistive-Capacitive) delay circuitry to set the dead time between turning ON and OFF the corresponding switches. This method is simple but unfortunately results in lower efficiency since the dead time has to be set long enough to cover the whole load/input range and to cover other variations such as temperature variations. Another way is to set the dead time by detecting the switch-body diode conduction and modifying the dead time accordingly. This method reduces body diode losses and therefore improves efficiency. However, the body diodes still conduct and losses are still considerable especially at higher switching frequencies and higher output currents. It is also difficult to implement in isolated topologies because of the delays caused by the isolators used in generating the drive signals and the transformer leakage inductance, which vary at different load and line conditions.

### SUMMARY OF THE INVENTION

A power converter in accordance with an aspect of the invention has a control method that optimizes efficiency by dynamically optimizing a controlled parameter. A change in efficiency of the converter after changing at least one controlled parameter is determined. The direction of change in efficiency of the converter is compared to a direction of the change in the controlled parameter. The controlled parameter is changed in a positive direction when the direction in the change in the efficiency of the converter and the direction of the change in the controlled parameter are the same and changed in a negative direction when the direction in the change in the efficiency of the converter and the direction of the change in the controlled parameter are opposite.

In an aspect of the invention, the controlled parameter includes dead time between turn-on and turn-off and between turn-off and turn-on of the primary and corresponding secondary side SR switches of the controller and drive voltage(s) for the switches.

In an aspect of the invention, the controlled parameter includes drive voltage(s) for the switches.

In an aspect of the invention, the controlled parameter includes the dead time and the drive voltage(s).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a basic flow chart of the inventive method;

FIG. 2 is a simplified schematic of an isolated half-bridge DC-DC converter, taken as example and not for limitation, controlled using the inventive method to optimize dead time;

FIG. 3 is a timing diagram showing the main switching waveforms of the DC-DC converter of FIG. 2;

FIG. 4 is a graph showing efficiency versus dead time when the inventive method is used to optimize dead time in controlling the DC-DC converter of FIG. 2;

FIGS. 5A and 5B are graphs showing efficiency versus dead time curves that show how the inventive method is used to optimize dead time at different load conditions and at different input voltage;

FIG. 6 is a flow chart of the inventive method used to optimize dead time in controlling the DC-DC converter of FIG. 2;

FIG. 7 is a simplified schematic of an isolated half-bridge DC-DC converter controlled using the inventive method to optimize drive voltages of the switches;

FIG. 8 is a flow chart of the inventive method used to optimize drive voltages in controlling the DC-DC converter of FIG. 7; and

FIG. 9 is a simplified schematic of an isolated forward converter controlled using the inventive method to optimize drive voltages of the switches.

### DETAILED DESCRIPTION OF THE PREFERRED EMBODIMENTS

The following description of the preferred embodiment(s) is merely exemplary in nature and is in no way intended to limit the invention, its application, or uses.

A method of controlling power converters in accordance with this invention, referred to herein as Maximum Efficiency Point Tracking (“MEPT”), tracks system efficiency and dynamically optimizes one or more system parameters, referred to herein as “controlled parameters” to maximize efficiency, or in other words minimum input power point causing efficiency maximization. In this regard, a system or controlled parameter is a parameter affecting operation of the system that is controlled or varied to optimize efficiency. The inventive MEPT method tracks the efficiency of the converter to find the optimized value of the parameter(s) that are dynamically adjusted by tracking the direction of change of the efficiency (ΔEff.) of the converter, that is, whether it is increasing or decreasing, and the direction of change of the controlled parameter (ΔCP), that is, whether it is being incremented or decremented and dynamically adjusting the controlled parameter accordingly.

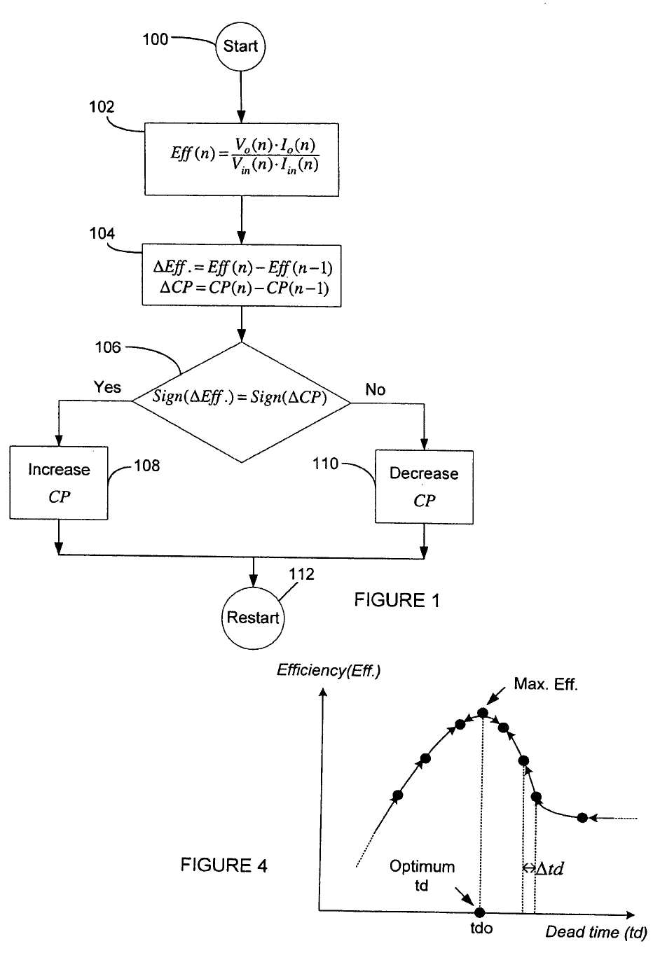

FIG. 1 shows a basic single cycle algorithm flowchart for the inventive MEPT method. The MEPT method starts at 100 and at 102, calculates the efficiency of the converter (Eff(n)) using equation (1) below. At 104, the change in efficiency of the converter (ΔEff.) is calculated using equation (2) below as is the change in the controlled parameter ΔCP using equation (3) below. At 106, the method determines whether ΔEff. and ΔCP are moving in the same direction (that is, whether they have the same sign). If so, the method branches to 108, where the controlled parameter (CP) is changed in the same direction as it was in the previous step change and the method then restarts at 112. If ΔEff. and ΔCP are moving in the opposite direction, the method branches to 110 and the controlled parameter (CP) is changed in the opposite direction of how it was changed in the previous step change.

$$\begin{matrix}Eff ( n ) = \frac{{V}_{o} ( n ) \cdot {I}_{o} ( n )}{{V}_{in} ( n ) \cdot {I}_{in} ( n )} & ( 1 ) \\ Δ Eff . = Eff ( n ) - Eff ( n - 1 ) & ( 2 ) \\ Δ CP = CP ( n ) - CP ( n - 1 ) & ( 3 )\end{matrix}$$

(Eff(n) is the current efficiency value under the current controlled parameter value CP(n) and Eff(n−1) is the previous efficiency value under the previous controlled parameter value CP(n−1)).

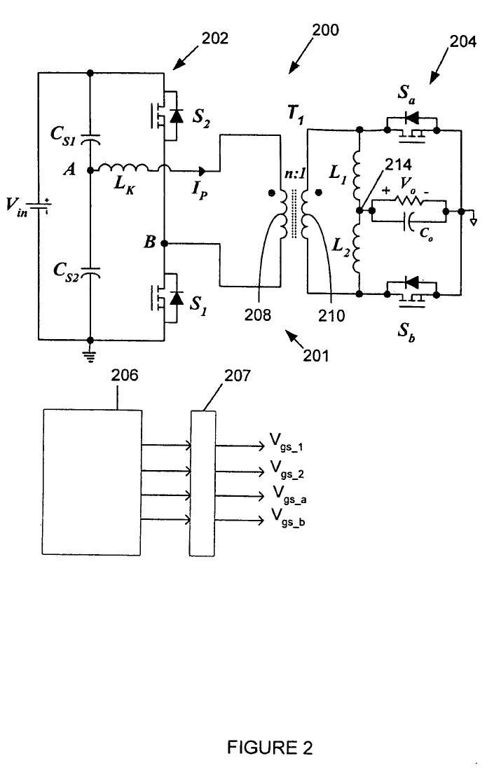

The inventive MEPT method is now described with reference to the example of FIG. 2, which shows an isolated half-bridge DC-DC converter 200 having a power converter circuit 201 with an input side, in this example, primary side 202, and an output side, in this example, secondary side 204. In the example of FIG. 2, secondary side 204 is a current doubler. Converter 200 is controlled by controller 206 that has outputs coupled to switching inputs of primary switches S₁, S₂ and secondary switches Sₐ, S_{b}, illustratively through driver circuit 207. Switches S₁, S₂, Sₐ, S_{b} are illustratively FETs with their switching inputs being their gates. Driver circuit 207 may, as is known, include drivers for each of the primary and secondary switches, such as UCC37321 or LM5101 drivers. In this illustrative embodiment, the inventive MEPT method tracks the efficiency of converter 200 and optimizes the primary-to-secondary switches dead time parameter(s) to prevent body diode conduction of the switches during freewheeling periods to reduce body diode conduction and reverse recovery losses to improve efficiency.

The inventive MEPT method is illustratively implemented in controller 206. In this regard, controller 206 may, by way of example and not of limitation, be a microcontroller and the control for converter 200 implemented by software programmed in controller 206. It should be understood that controller 206 and the control functions it implements could be hard wired digital logic, application specific integrated circuits, and the like. It should be understood that the description of the inventive MEPT method as applied to converter 200 is by way of example and not of limitation, and the MEPT method can be applied to converters other than the isolated half-bridge DC-DC converter. Converter 200 can be controlled using conventional symmetric control, asymmetric (complementary) control, or duty—cycle-shifted (DCS) control. In the following example, converter 200 is DCS controlled but it should be understood that this is by way of example and not of limitation as other types of control, such as those just mentioned, can also be used to control converter 200.

Primary side 202 of converter 200 has primary switches S₁, S₂, and capacitors C_{S1}, C_{S2}. A plus side of a DC voltage source Vᵢₙ is coupled to one side of capacitor C_{S1} and to one side of primary switch S₂. A negative or common side of Vᵢₙ is coupled to common as is one side of capacitor C_{S2} and one side of primary switch S₁. Second sides of capacitors C_{S1} and C_{S2} are coupled together at junction A and second sides of primary switches S₁, S₂ are coupled together at junction B. Junction A is coupled to one side of a primary winding 208 of a transformer T₁ and junction B is coupled to the other side of primary winding 108 of transformer T₁.

Secondary side 204 of converter 200 includes secondary switches Sₐ, S_{b}, inductors L₁, L₂, and output capacitor Cₒ, which are coupled together in a current doubler topology as mentioned. One side of secondary switch Sₐ is coupled to one side of secondary winding 210 of transformer T₁ and to one side of inductor L₁, and a second side of secondary switch Sₐ is coupled to common. One side of secondary switch S_{b} is coupled to the other side of secondary winding 210 of transformer T₁ and to one side of inductor L₂. Second sides of inductors L₁, L₂ are coupled together and provide a positive output 214 of converter 200. Output capacitor Cₒ is coupled between the junction of inductors L₁, L₂ and common.

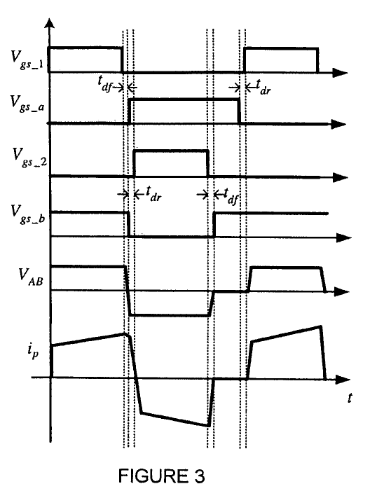

FIG. 3 shows the main switching waveforms used by controller 206 to control converter 200 using DCS control as mentioned. As shown in FIG. 3, there is a dead time (t_{dr}) between the rising edges of the gating signals (V_{gs}_{_{—}}₁, V_{gs-2}) for the primary side switches S₁, S₂ and the falling edges of the gating signals (V_{gs}_{_{—}}ₐ, V_{gs-b}) for the corresponding secondary side switches Sₐ, S_{b} and a dead time (t_{df}) between the falling edges of the gating signals (V_{gs}_{_{—}}₁, V_{gs-2}) for the primary side switches S₁, S₂ and the rising edges of the gating signals (V_{gs}_{_{—}}ₐ, V_{gs-b}) for the corresponding secondary side switches Sₐ, S_{b}. To reduce the corresponding body diode losses of Sₐ and S_{b}, t_{dr} and t_{df} should be optimized. For simplicity and discussion purposes, it is assumed that t_{dr}=t_{df}=t_{d}, even though it may not be true in practical cases. If t_{dr} and t_{df} are not equal, then they may be given different initial values or an optimization algorithm used for each.

FIG. 4 shows an efficiency versus dead time (t_{d}) curve that illustrates the use of the inventive MEPT method to optimize dead time (t_{dr}, t_{df}) when the control variable to be optimized is the dead time (CP=t_{d}). In FIG. 4, t_{do} is the optimum dead time value that results in maximum efficiency. As t_{d} becomes larger than t_{do}, the efficiency of the converter decreases up to the point where the switches' body diodes conduct for the whole range when the voltage is applied and the efficiency drops to zero. As t_{d} becomes smaller than t_{do}, the efficiency drops rapidly due to the short circuit caused by both secondary side switches being on when the voltage is applied from the primary side.

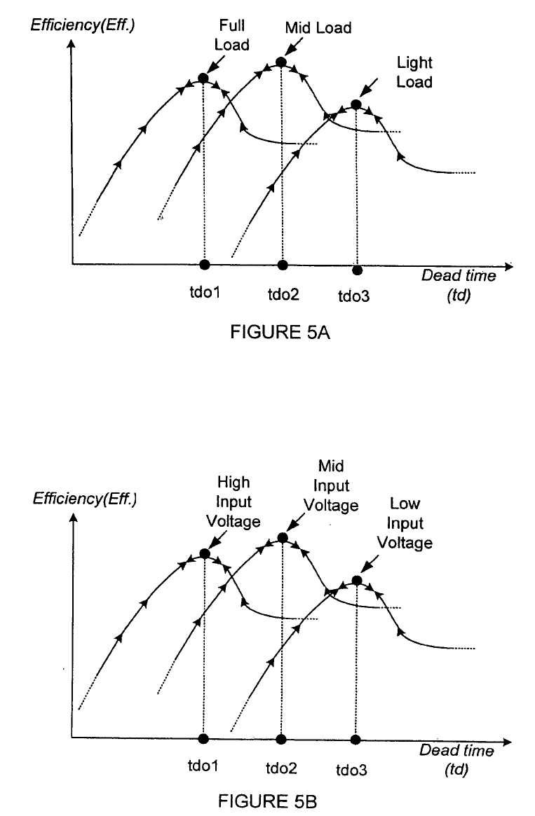

FIGS. 5(a) and 5(b) show efficiency versus dead time curves that show how the inventive MEPT method is used to optimize dead time at different load and input voltage conditions. The MEPT method tracks the efficiency of the converter, such as converter 200, and updates the optimized dead time value as the efficiency of the converter changes due to varying conditions. This results in a significant efficiency improvement compared to a converter without the MEPT control method, especially at higher load currents and switching frequencies with wide load and line variations.

Calculating the efficiency of a converter requires accurate sensing and use of four signals, i.e., the output voltage (Vₒ) of the converter, the output current (Iₒ) of the converter, the input voltage (Vᵢₙ) of the converter, and the input current (Iᵢₙ) of the converter. It also requires three multiplications, which use large controller resources and calculation time. Moreover, since the efficiency calculation involves the use of four sensed signals, calculation error is magnified due to any errors in sensing the four signals.

A closer look at these four signals shows that for certain line (Vᵢₙ) and load (Iₒ) points at a fixed regulated output voltage (Vₒ), the input current (Iᵢₙ) is a sufficient parameter to indicate the change in the converter efficiency, that is, whether the converter efficiency is increasing or decreasing. The maximum efficiency point occurs at the minimum input current point for a given input voltage, i.e., for fixed Vᵢₙ, Iₒ, and Vₒ, the converter efficiency is higher when Iᵢₙ is smaller since the converter input power will be minimized for a fixed output power. Therefore Iᵢₙ is illustratively used to determine converter efficiency in the implementation of the MEPT method as described below. Note that using Iᵢₙ to determine converter efficiency means that implementing the MEPT method does not require sensing any additional signals beyond those usually sensed, since Iᵢₙ is usually sensed anyway for protection and/or control purposes.

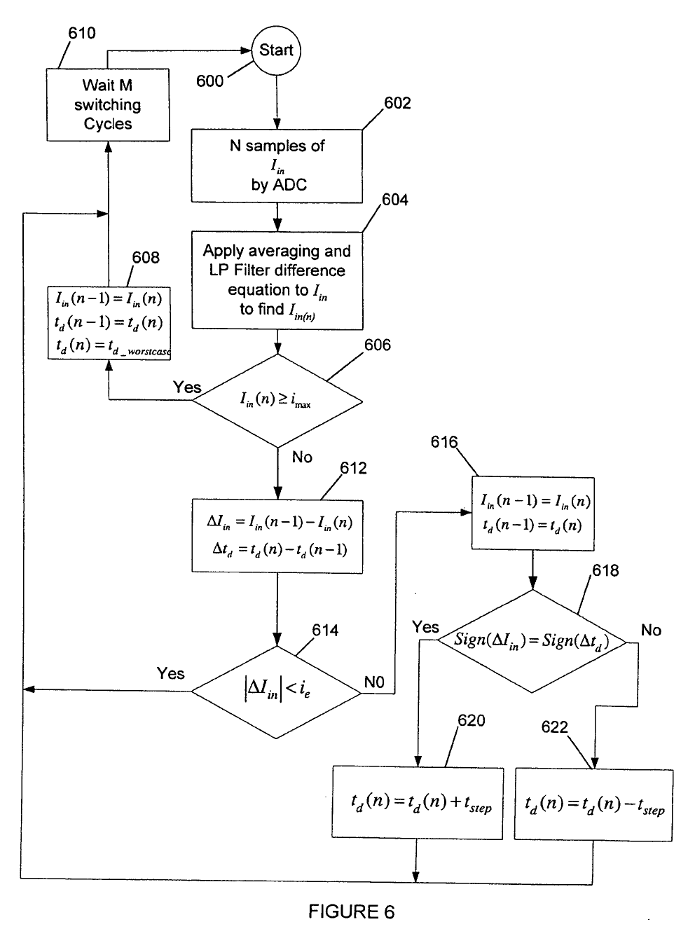

FIG. 6 shows an illustrative flowchart of a software program to implement the MEPT method to control dead time. The program is illustratively implemented in controller 206 (FIG. 2) and the program will be described with reference to converter 200 and controller 206. The program starts at 600 and at 602, N samples of Iᵢₙ are acquired, such as by use of an analog-to-digital converter that may illustratively be included in controller 206, which are then stored, such as in a memory of controller 206, and then at 606 averaged and filtered by a conventional low pass digital filter difference equation to eliminate noise and generate Iᵢₙ(n). Iᵢₙ(n) is compared at 606 to a maximum current value iₘₐₓ for over current protection. This protection is added in case that t_{d} is set too small by mistake and caused a short circuit. If Iᵢₙ(n)≧iₘₐₓ, t_{d} is set to a worst case value t_{d}_{_{—}}_{worstcase} at 608 and the program then branches to 600 to restart the process after waiting a predetermined number of switching cycles at 610. If Iᵢₙ(n)<iₘₐₓ, the difference between the previous value and the new value of Iᵢₙ and the difference between the current value and the previous value of t_{d} are calculated at 612 using equations (4) and (4) below.
ΔIᵢₙ=Iᵢₙ(n−1)−Iᵢₙ(n) (4)
Δt_{d}=t_{d}(n)−t_{d}(n−1) (5)

At 614, a check is made to see if ΔIᵢₙ has sufficient value (iₑ) to update t_{d}. If so, the program proceeds to 616. If not, the program branches back to start after waiting a predetermined number of switching cycles at 610.

At 616, Iᵢₙ (n−1) and t_{d}(n−1) are updated by setting them equal to Iᵢₙ (n) and t_{d} (n), respectively.

At 618, a check is made to determine if the signs (positive or negative) of Equations (4) and (5) are the same. If they are, the current efficiency-dead time point is located on the left side of t_{do} as shown in FIG. (4) and at 620 t_{d} is incremented by tₛₜₑₚ to move towered the maximum efficiency point. If not, the current efficiency-dead time point is located on the right side of t_{do} as shown in FIG. (4) and at 622 t_{d} is decremented by tₛₜₑₚ to move toward the maximum efficiency point.

The program then branches back to start after waiting a predetermined number of switching cycles at 610.

Dead time is only one of the system parameters that can be optimized using the inventive MEPT method to improve the efficiency of the converter. Examples of other parameters include the driving voltages value(s) applied to gates of the FETs that are typically used as the primary and secondary side switches, switching frequency applied to primary-side switches, the dead time between high and low side switches, and intermediate bus voltages in cascaded converter systems. The MEPT method dynamically tracks the maximum efficiency by adjusting those parameters with the input voltage variation, load change and ambient temperature change. For example, the driving voltages affect the conduction loss and drive loss. The higher drive voltage, the more drive loss and less conduction loss. Under certain load and input voltage condition, there exists an optimum drive voltage corresponding to maximum efficiency. Peak efficiency under a set of optimized parameters varies for different load and converter input voltages. The inventive MEPT method searches for a set of optimum parameters to peak the efficiency. For multi-parameter optimization, the efficiency peaking may be done sequentially. For example, if dead time values, drive voltage values and intermediate bus voltage values are adjusted in a system to peak efficiency, the bus voltage values can be optimized first, then driving voltages values and then dead time values. After all three parameters are adjusted, or after a certain interval, the method starts the sequence over. It should be understood that these parameters can be adjusted in other sequential orders. That is, driving voltages values or dead time could be adjusted first followed by the sequential adjustment of the other two parameters. Other advanced multi-dimension searching methods may be utilized to peak the efficiency.

In the example described below, the voltage of the gate signals used to drive the primary side switches, the secondary side switches, or both, is advantageously optimized using the inventive MEPT method to optimize converter efficiency. The driving voltage applied to the gates of FETs, which are typically used as the primary and secondary side switches in a converter, causes stored charge to be accumulated in the internal gate-to-drain and gate-to-source capacitances of the FETs. Repeatedly discharging this stored charge results in a power loss, and thus decreased efficiency. At the same time, the level of voltage applied to a FET gate influences conduction characteristics (Rdsₒₙ) of the FET, which also results in a power loss. These two effects tend to work in opposite directions—a higher gate voltage results in lower Rdsₒₙ but also results in a higher gate charge and higher drive loss.

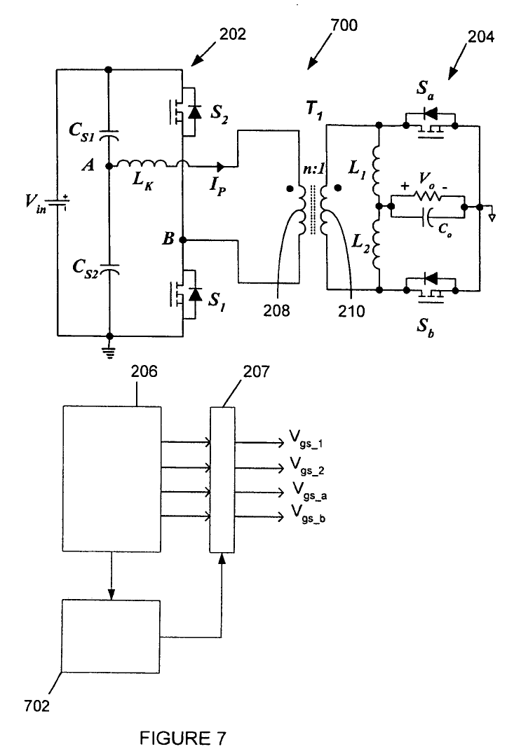

Because these two effects have opposing slope, an optimum value exists for the driving voltage to minimize net power loss in switching the FET which is optimized using the inventive MEPT method as described below with reference to FIG. 7. FIG. 7 shows an isolated DC-DC converter 700 having a similar topology to that shown in FIG. 2. Elements common to both DC-DC converter 200 of FIG. 2 and DC-DC converter 700 will be identified with the same reference numbers and the discussion will focus on the differences.

In converter 700, a variable voltage source 702 has a voltage output(s) coupled to a voltage input(s) of driver circuit 207 and has control inputs coupled to outputs of controller 206. Variable voltage source 702, under control of controller 206, provides the voltage(s) to driver circuit 207 that driver circuit 207 switches to the gates of primary switches S₁, S₂, secondary switches Sₐ, S_{b}, or both, under control of controller 206.

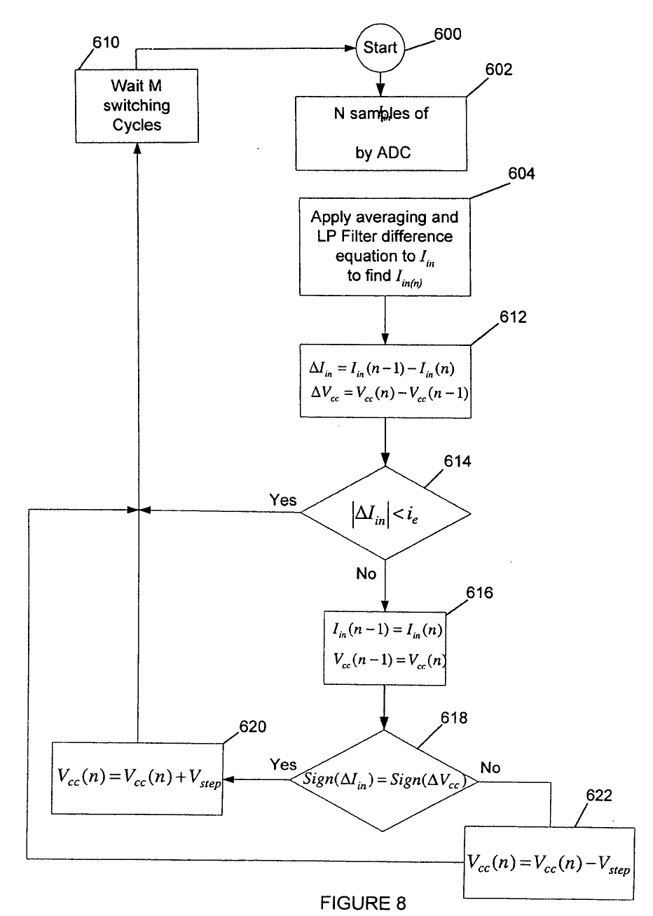

The MEPT method is again illustratively implemented in controller 206 and optimizes the voltage provided by voltage source 702 that is applied to the gates of primary and secondary side switches S₁, S₂, Sₐ, S_{b} (which are illustratively FETs) by driver circuit 207 to switch them. FIG. 8 is a flow chart of a program for this illustrative MEPT method. This flow chart is essentially identical to the flow chart of FIG. 6, the principal difference being that the controlled parameter is the voltage provided by voltage source 702 (V_{cc}), which is the drive voltage for driving the gates of primary and secondary side switches S₁, S₂, Sₐ, S_{b}. (Since V_{cc} is the controlled parameter, steps 606 and 608 of the flow chart of FIG. 6 are not needed.)

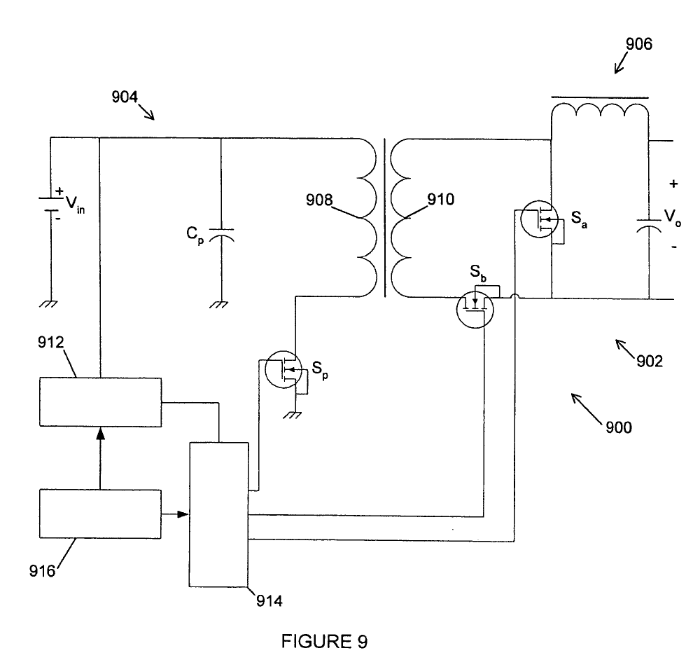

FIG. 9 shows an isolated forward converter topology in which the inventive MEPT method is used to optimize the drive voltage(s) for the input and/or output side switches. Converter 900 includes a power converter circuit 902 having an input side 904 and an output side 906 coupled via a transformer T₁. One side of a primary winding 908 of transformer T₁ is coupled to a plus side of a voltage source Vᵢₙ as is one side of a capacitor Cₛ of input side 904. A switch Sₚ of input side 904 is coupled between the other side of primary winding 908 of transformer T₁ and common. Output side 906 includes switches Sₐ, S_{b}, inductor L and output capacitor Cₒ. A junction of switch Sₐ and inductor L is coupled to one side of secondary winding 910 of transformer T₁. The other side of secondary winding 910 is coupled to one side of output side switch S_{b}. Output capacitor Cₒ is coupled between a second side of inductor L and a junction of output side switches Sₐ, S_{b}. Converter 900 further variable voltage source 912 having a voltage output(s) coupled to voltage input(s) of a driver circuit 914, which has control inputs coupled to outputs of a includes controller 916. Variable voltage source 912, under control of controller 916, provides the voltage(s) to driver circuit 914 that driver circuit 914 switches to gates of primary switch Sₚ and secondary switches Sₐ, S_{b}, or both, under control of controller 916. Controller 916 utilizes the inventive MEPT method to optimize the drive voltage(s) provides to the gates of primary switch Sₚ, and/or secondary switches Sₐ, S_{b} in the same manner as controller 206 as described above with reference to FIGS. 7 and 8.

It should be understood that the inventive MEPT method can be used to control more than one parameter of a converter. For example, it could be used to control both dead time(s), as discussed above with reference to FIGS. 2 and 6, and drive voltage(s) for the primary and secondary side switches, discussed above with reference to FIGS. 7-9.

The description of the invention is merely exemplary in nature and, thus, variations that do not depart from the gist of the invention are intended to be within the scope of the invention. Such variations are not to be regarded as a departure from the spirit and scope of the invention.

1. A method of controlling a power converter to optimize efficiency, comprising:
a. determining a direction of change in efficiency of the converter after changing at least one controlled parameter;
b. comparing the direction of change in efficiency of the converter to a direction of the change in the controlled parameter; and
c. changing the controlled parameter in a positive direction when the direction in the change in the efficiency of the converter and the direction of the change in the controlled parameter are the same and changing the controlled parameter in a negative direction when the direction in the change in the efficiency of the converter and the direction of the change in the controlled parameter are opposite.

2. The method of claim 1 wherein the power converter is a DC-DC converter and the controlled parameter is dead time between turn-on of at least one primary side switch of the converter and turn-off of a corresponding secondary side switch of the converter and between turn-off of the primary side switch and turn-on of the corresponding secondary side switch, and changing the controlled parameter in the positive direction includes adjusting a switching signal for at least one of the primary and secondary side switches to increase the dead time and changing the controlled parameter in the negative direction includes adjusting the switching signal for at least one of the primary and secondary side switches to decrease the dead time.

3. The method of claim 1 wherein the power converter is a DC-DC converter and the controlled parameter includes dead time between turn-on of primary side switches of the converter and turn-off of corresponding secondary side switches of the converter and between turn-off of the primary side switches and turn-on of the corresponding secondary side switches, and changing the controlled parameter in the positive direction includes adjusting switching of the primary and secondary side switches to increase dead time and changing the controlled parameter in the negative direction includes adjusting switching of the primary and secondary side switches to decrease dead time.

4. The method of claim 1 wherein the power converter is a DC-DC converter and the controlled parameter includes a drive voltage for at least one of an input and output side switch and changing the controlled parameter in the positive direction includes increasing the drive voltage and changing the controlled parameter in the negative direction includes decreasing the drive voltage.

5. The method of claim 1 wherein the power converter is a DC-DC converter and the controlled parameter includes drive voltages for input and output side switches and changing the controlled parameter in the positive direction includes increasing the drive voltages and changing the controlled parameter in the negative direction includes decreasing the drive voltages.

6. The method of claim 1 wherein the controlled parameter includes a plurality of controlled parameters including dead time between turn-on of primary side switches of the converter and turn-off of corresponding secondary side switches of the converter and between turn-off of the primary side switches and turn-on of the corresponding secondary side switches and drive voltages for the primary and secondary side switches.

7. The method of claim 6 wherein the converted is a cascaded converter and the plurality of controlled parameters also includes intermediate bus voltages.

8. The method of claim 1 wherein the power converter is a cascaded power converter and the controlled parameter includes intermediate bus voltages.

9. A method of controlling a DC-DC converter to optimize efficiency, comprising:
a. determining a direction of change in efficiency of the converter after changing dead time between turn-on of primary side switches of the converter and turn-off of corresponding secondary side switches of the converter and between turn-off of the primary side switches and turn-on of the corresponding secondary side switches,
b. comparing the direction of change in efficiency of the converter to a direction of the change in the dead time;
c. increasing the dead time when the direction in the change in the efficiency of the converter and the direction of the change in the dead time are the same and decreasing the dead time in a when the direction in the change in the efficiency of the converter and the direction of the change in the dead time are opposite;
d. determining a direction of change in efficiency of the converter after changing a drive voltage for at least one of the primary and secondary side switches;
e. comparing the direction of change in efficiency of the converter to a direction of the change in the driving voltage;
f. increasing the driving voltage when the direction in the change in the efficiency of the converter and the direction of the change in driving voltage are the same and decreasing the driving voltage when the direction in the change in the efficiency of the converter and the direction of the change in the dead time are opposite.

10. The method of claim 9 wherein the drive voltage includes drive voltages for the primary and secondary side switches.

11. A power converter, comprising:
a. a power converter circuit;
b. a controller coupled to power converter circuit that determines a direction of change in efficiency of the converter after changing at least one controlled parameter, compares the direction of change in efficiency of the converter to a direction of the change in the controlled parameter, and changes the controlled parameter in a positive direction when the direction in the change in the efficiency of the converter and the direction of the change in the controlled parameter are the same and changes the controlled parameter in a negative direction when the direction in the change in the efficiency of the converter and the direction of the change in the controlled parameter are opposite.

12. The power converter of claim 11 wherein the power converter is a DC-DC converter and the controlled parameter is dead time between turn-on of the primary side switch of the converter and turn-off of a corresponding secondary side switch of the converter and between turn-off of the primary side switch and turn-on of the corresponding secondary side switch, the controller adjusting a switching signal for at least one of the primary and secondary side switches to increase the dead time to change the controlled parameter in the positive direction and adjusts the switching signal for at least one of the primary and secondary side switches to decrease the dead time to change the controlled parameter in the negative direction.

13. The power converter of claim 11 wherein the power converter is a DC-DC converter having primary and secondary side switches and the controlled parameter includes a drive voltage for at least one of the primary and secondary side switches, the controller increasing the drive voltage to change the controlled parameter in the positive direction and decreasing the drive voltage to change the controlled parameter in the negative direction.

14. The power converter of claim 11 wherein the power converter is a DC-DC converter having primary and secondary side switches and the controlled parameter includes drive voltages for the primary and secondary side switches, the controller increasing the drive voltages to change the controlled parameter in the positive direction and decreasing the drive voltage to change the controlled parameter in the negative direction.

15. The power converter of claim 11 wherein the power converter is a DC-DC converter and the controlled parameter includes a plurality of controlled parameters including dead time between turn-on of primary side switches of the converter and turn-off of corresponding secondary side switches of the converter and between turn-off of the primary side switches and turn-on of the corresponding secondary side switches and drive voltages for the primary and secondary side switches.

16. The power converter of claim 11 wherein the power converter is a cascaded converter and the controlled parameter includes a plurality of controlled parameters including dead time between turn-on of primary side switches of the converter and turn-off of corresponding secondary side switches of the converter and between turn-off of the primary side switches and turn-on of the corresponding secondary side switches, drive voltages for the primary and secondary side switches, and intermediate bus voltages.

17. A DC-DC converter, comprising:
a. a primary side having a plurality of primary side switches and a secondary side having a plurality of secondary side switches; and
b. a controller coupled to the primary side and secondary side that determines a direction of change in efficiency of the converter after changing dead time between turn-on of the primary side switches and turn-off of corresponding secondary side switches and between turn-off of the primary side switches and turn-on of the secondary side switches, compares the direction of change in efficiency of the converter to a direction of the change in the dead time, increases the dead time when the direction in the change in the efficiency of the converter and the direction of the change in the dead time are the same and decreases the dead time when the direction in the change in the efficiency of the converter and the direction of the change in the dead time are opposite.

18. A DC-DC converter, comprising:
a. an input side having at least one input side switch and an output side having at least one output side switch; and
b. a controller coupled to the input and output sides that determines a direction of change in efficiency of the converter after changing a drive voltage for at least one of the input and output side switches, compares the direction of change in efficiency of the converter to a direction of the change in the drive voltage, increases the drive voltage when the direction in the change in the efficiency of the converter and the direction of the change in the drive voltage are the same and decreases the drive voltage when the direction in the change in the efficiency of the converter and the direction of the change in the drive voltage are opposite.

19. A DC-DC converter, comprising:
a. an input side having at least one input side switch and an output side having at least one output side switch; and
b. a controller coupled to the input and output sides that determines a direction of change in efficiency of the converter after changing drive voltages for the input and output side switches, compares the direction of change in efficiency of the converter to a direction of the change in the drive voltages, increases the drive voltages when the direction in the change in the efficiency of the converter and the direction of the change in the drive voltage are the same and decreases the drive voltages when the direction in the change in the efficiency of the converter and the direction of the change in the drive voltages are opposite.

20. A DC-DC converter, comprising:
a. input and output side switches; and
b. a controller coupled to the input and output sides that determines a direction of change in efficiency of the converter after changing drive voltages for the input and output side switches, compares the direction of change in efficiency of the converter to a direction of the change in the drive voltages, increases the drive voltages when the direction in the change in the efficiency of the converter and the direction of the change in the drive voltages are the same and decreases the drive voltages when the direction in the change in the efficiency of the converter and the direction of the change in the drive voltages are opposite.

21. A DC-DC converter, comprising:
a. primary and secondary side switches;
b. a controller coupled to the primary side and secondary side switches;
c. the controller determining a direction of change in efficiency of the converter after changing dead time between turn-on of the primary side switches and turn-off of corresponding secondary side switches and turn-off of the primary side switches and turn-on of the corresponding secondary side switches, compares the direction of change in efficiency of the converter to a direction of the change in the dead time, and adjusts switching signals for the primary and secondary side switches to increase the dead time when the direction of change in converter efficiency is the same as the direction of change in dead time and adjust the switching signals to decrease dead time when the direction of change in converter efficiency is opposite the direction of change in dead time; and
d. the controller also determining a direction of change in efficiency of the converter after changing a drive voltage for at least one of the primary and secondary side switches, comparing the direction of change in efficiency of the converter to a direction of the change in the drive voltage, increasing the drive voltage when the direction in the change in the efficiency of the converter and the direction of the change in the drive voltage are the same and decreasing the drive voltage when the direction in the change in the efficiency of the converter and the direction of the change in the drive voltage are opposite.

22. The converter of claim 20 wherein the drive voltage includes drive voltages for the primary and secondary side switches.
